(19) United States
(12) Patent Application Publication
(10) Pub. No.: US 2008/0306728 A1
(43) Pub. Date: Dec. 11, 2008

(54) APPARATUS, METHOD, AND COMPUTER PROGRAM PRODUCT FOR MACHINE TRANSLATION

(76) Inventors: Satoshi KAMATANI, Kanagawa (JP); Tetsuro CHINO, Kanagawa (JP); Kentaro FURIHATA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/050,563

(22) Filed: Mar. 18, 2008

(30) Foreign Application Priority Data
Jun. 7, 2007 (JP) 2007-151735

(51) Int. Cl. G06F 17/28

(52) U.S. Cl. 704/7; 704/2

(57) ABSTRACT

A receiving unit receives an input sentence in a source language. An example translation candidate translated from the input sentence into a target sentence and a first likelihood of the example translation candidate are obtained. A generating unit translates the input sentence into the target language by a process different from a process of an example translating unit, and among candidates for a translation result with each word in the input sentence, generates a translation word candidate showing a candidate whose second likelihood is equal to or more than a first threshold value. When a translation word included in the example translation candidate is not included in the translation word candidate, a changing unit lowers the first likelihood by only a predetermined value. A selecting unit selects the example translation candidate whose first likelihood is a maximum, from the example translation candidate.

### CROSS-REFERENCE TO RELATED APPLICATIONS

This application is based upon and claims the benefit of priority from the prior Japanese Patent Application No. 2007-151735, filed on Jun. 7, 2007; the entire contents of which are incorporated herein by reference.

### BACKGROUND OF THE INVENTION

1. Field of the Invention

The present invention relates to an apparatus, a method, and a computer program product that translate a source language sentence into a target language sentence, by combining a plurality of translation systems including a translation system that performs translation by referring to a similar translation example.

2. Description of the Related Art

As a translation system in a machine translation apparatus in a related art that converts a source language sentence expressed in a first language into a second language to output it, a rule-based translation system, a statistics-based translation system, an example-based translation system, and the like are known.

The rule-based translation system is a translation system that gives a method of translation by rules, with such conditions as words that form a source language sentence, a syntax structure of the source language sentence, and a semantic interpretation. The statistics-based translation system is a translation system that learns language behavior of the source language and the target language, and linguistic phenomena observed during the translation between the source language and the target language, using probability statistics.

The example-based translation system is a translation system that generates a desired translation sentence by imitating a translation example that serves as a model, such as a past translation example and a sample translation by a human translator. The example-based translation system, compared with the rule-based translation system and the statistics-based translation system, can obtain a natural and a fluent translation, and has an advantage that can correspond to a new input, simply by adding an example. Therefore, the example-based translation system has been much studied in recent years, and a translation apparatus installed with the technology has been put to practical use.

One of the important issues that affect the performance of the example-based translation system is the quality and the scale of a collection of examples that is referred by a translation apparatus installed with the system. Accuracy to search a similar example that is most appropriate for the input sentence is also an important issue affecting the performance of the example-based translation system.

Considering the diversity of natural languages, translations that should be included in the collection of examples is far from limited. Therefore, a technique to search an appropriate example sentence from limited examples with higher accuracy may be said to be the key to the example translation.

For example, in JP-A 2004-62726 (KOKAI), a technology that provides an example searching technique with higher accuracy, and a translation apparatus that includes a highly accurate example-based translation system are disclosed. These are enabled, while searching an example, by searching a degree of similarity of the target language side, as well as a degree of similarity of the source language side being the first language.

For example, assume that a Japanese sentence J1 that means “I feed a mouse.” and a corresponding English sentence E1 “I feed a mouse.” are included in a collection of examples. Then, assume that an English source sentence E2 “I feed a seal.” is input as a translation target. At this time, in a method of the JP-A 2004-62726 (KOKAI), a degree of similarity between the “seal” in the source sentence E2 and the “mouse” in the English sentence E1, and a degree of similarity between a word that means a “seal” in a Japanese sentence being a translation sentence and a corresponding word in the Japanese sentence J1 that means a “mouse”, are calculated. Because both words indicate an animal, they are determined to be similar, whereby the system adopts the example. In other words, the English sentence E1 is being searched as a similar example, and a Japanese translation sentence that means “I feed a seal.” is output as a translation result.

According to the method of the JP-A 2004-62726 (KOKAI), the performance may be improved, by evaluating ambiguities of both the source language side and the target language side.

However, some examples show that the strength of the similarities of both the source language side and the target language side does not necessarily lead to an accurate and a natural translation sentence. For example, based on the above example, when an English source sentence E3 “I feed my son.” is input, the same example is adopted under the same judgment. As a result, an inappropriate Japanese translation sentence that means “I feed my son.” is output.

In this example, because the word “feed” in English has various meanings, when translating it into Japanese, an appropriate translation word needs to be selected from a plurality of translation words, depending on a context. However, in the method of the JP-A 2004-62726 (KOKAI), because only a degree of similarity between the words that correspond to a mismatch portion of the example is considered, an inappropriate Japanese translation may be selected as a result.

For example, assume that a Japanese sentence J2 that means “I'm baking bread.”, and an example that is associated with a corresponding English sentence E4 “I'm baking bread.” are included in a collection of examples. Then, assume that a Japanese source sentence J3 that means “I'm making soup.” is input as a translation target. In this case, because “bread” and “soup” that correspond to a mismatch portion are both food, the above example is adopted. As a result, an unnatural translation such as “I'm baking soup.” is generated.

This is a problem that is difficult to avoid, even if carefully examined examples are included in the collection of examples, as long as the translation is performed within limited examples. However, this is a major issue, because users who have no alternative but to believe the searched examples and the translation sentences being output suffer disadvantages.

### SUMMARY OF THE INVENTION

According to one aspect of the present invention, a machine translation apparatus includes an example storage unit configured correspondingly to store an example in a source language and an example in a target language translated from the example in the source language; a receiving unit configured to receive an input sentence in the source language; an example translating unit configured to perform an example translation process of obtaining a plurality of example translation candidates translated from the input sentence into the target language, each of which is correlated with a first likelihood indicating a certainty of each of the example translation candidates, based on the example in the target language stored in the example storage unit corresponding to the example in the source language that coincides or nearly coincides with the input sentence; a generating unit configured to translate the input sentence into the target language by another translation process different from the example translation process, and to generate a translation word candidate showing a candidate for a result of the another translation process with a second likelihood, indicating a certainty of the candidate for the result of the another translation process, being equal to or more than a predetermined first threshold value; a changing unit configured to determine whether a translation word corresponding to each word included in the example translation candidate exists in the translation word candidate, and to change the first likelihood by subtracting a predetermined value when the translation word does not exist in the translation word candidate; and a selecting unit configured to select the example translation candidate whose first likelihood is a maximum, from the example translation candidates.

According to another aspect of the present invention, a machine translation method includes receiving an input sentence in the source language; performing an example translation process of obtaining a plurality of example translation candidates translated from the input sentence into the target language, each of which is correlated with a first likelihood indicating a certainty of each of the example translation candidates, based on the example in the target language, stored in a example storage unit storing an example in a source language and an example in a target language translated from the example in the source language, corresponding to the example in the source language that coincides or nearly coincides with the input sentence; translating the input sentence into the target language by another translation process different from the example translation process; generating a translation word candidate showing a candidate for a result of the another translation process with a second likelihood indicating a certainty of the candidate for the result of the another translation process being equal to or more than a predetermined first threshold value; determining whether a translation word corresponding to each word included in the example translation candidate exists in the translation word candidate; changing the first likelihood by subtracting a predetermined value when the translation word does not exist in the translation word candidate; and selecting the example translation candidate whose first likelihood is a maximum, from the example translation candidates.

A computer program product according to still another aspect of the present invention causes a computer to perform the method according to the present invention.

### BRIEF DESCRIPTION OF THE DRAWINGS

FIG. 1 is a block diagram of a machine translation apparatus according to an embodiment of the present invention;

FIG. 2 is a diagram illustrating a data configuration of translation examples that are stored in an example storage unit;

FIG. 3 is a diagram illustrating an output format of example translation candidates that are output from an example translating unit;

FIG. 4 is a diagram illustrating conversion rules used by a translation-word-candidate generating unit;

FIG. 5 is a diagram illustrating translation word candidates being generated;

FIG. 6 is a diagram illustrating the translation word candidates after being added by a translation-word-candidate adding unit;

FIG. 7 is a flowchart of an overall flow of a machine translation process according to the present embodiment;

FIG. 8 is a flowchart of an overall flow of an evaluation process of example translation candidates;

FIG. 9 is a diagram illustrating alternative example translation candidates;

FIG. 10 is a diagram illustrating a collection of translation word candidates; and

FIG. 11 is a diagram illustrating a hardware configuration of the machine translation apparatus according to the present embodiment.

### DETAILED DESCRIPTION OF THE INVENTION

Exemplary embodiments of an apparatus, a method, and a computer program product for machine translation according to the present invention will be explained in detail below with reference to the accompanying drawings. In the following, a translation between Japanese and English will be used as an example, but a language to be translated is not limited to the two languages, but any language can be a target.

The machine translation apparatus according to an embodiment of the present invention narrows down translation candidates obtained by an example-based translation system, by referring to a translation result obtained by a rule-based translation system.

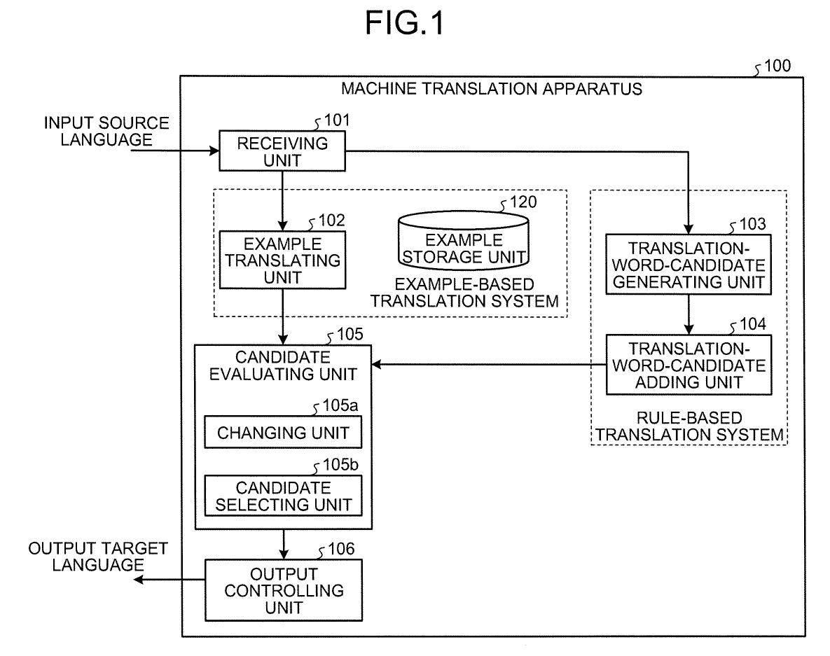

As shown in FIG. 1, a machine translation apparatus 100 includes an example storage unit 120, a receiving unit 101, an example translating unit 102, a translation-word-candidate generating unit 103, a translation-word-candidate adding unit 104, a candidate evaluating unit 105, and an output controlling unit 106.

The example storage unit 120 makes a pair of a sentence in a first language and a sentence in a second language that is in a mutual translation relationship with the sentence in the first language, and stores therein as translation examples. The example storage unit 120 stores therein a unit that forms a sentence in the first language and a unit that forms a sentence in the second language, as translation correspondence information that shows the translation relationship therebetween (hereinafter, translation alignment information), by corresponding to the translation examples. In the present embodiment, a word is used as a unit, and in the following, a word is used to explain as a unit. However, a unit that forms a sentence is not limited to a word, but other units such as a morpheme or a phrase may also be used.

Instead of statically holding the translation alignment information in the example storage unit 120 in advance, the translation alignment information may be formed so as to be dynamically estimated in the example translating unit 102, which will be explained later. In the present embodiment, only two languages are used to explain the corresponding example sentences. However, the example sentences may be formed so that two or more languages are correspondingly stored therein, and selectively extracted and used depending on an input language and a desired output language.

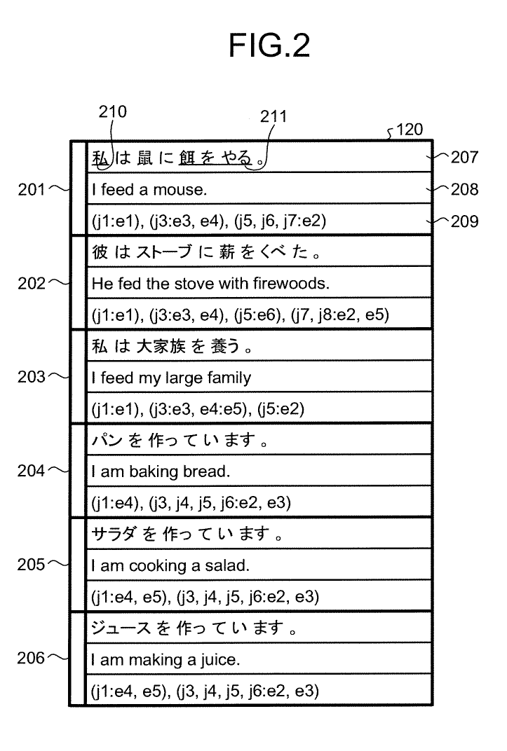

In an example shown in FIG. 2, six examples 201, 202, 203, 204, 205, and 206 are stored. In each example, a sentence in the first language and a sentence in the second language correspond to translation alignment information.

For example, in the example 201, a Japanese sentence 207 in Japanese being the first language corresponds to an English sentence 208 (“I feed a mouse.”) in English being the second language and in a mutual translation relationship with the Japanese sentence 207. Translation alignment information 209 that shows a correspondence between the words in the Japanese sentence 207 and the words in the English sentence 208 are correspondingly stored.

The translation alignment information is indicated by an identifier based on a position of a word that appears in each sentence. In regard to a sentence in which the translation example is described in Japanese, identifiers are given as “j1, j2, . . . ” in the word order. In regard to a sentence in which the translation example is described in English, identifiers are given as “e1, e2, . . . ” in the word order.

For example, the translation alignment information 209 shown in FIG. 2 is formed by three translation alignments of (j1:e1), (j3:e3, e4), and (j5, j6, j7:e3). The alignment (j1:e1) shows that the first Japanese word 210 is aligned with the first English word (“I”). The alignment (j3:e3, e4) shows that the third Japanese word is aligned with the third and the fourth English words (“a mouse”). The alignment (j5, j6, j7:e3) shows that a phrase 211 made of the fifth, the sixth, and the seventh Japanese words is aligned with the third English word (“feed”).

In the following explanation, among each sentence in the translation examples, a sentence that is described in the same language as an input sentence is called an example source sentence, and a sentence that is described in a translation destination language (target language) is called an example translation sentence.

The example storage unit 120 may be formed by any generally used storage media, such as a hard disk drive (HDD), an optical disk, a memory card, and a random access memory (RAM).

Referring back to FIG. 1, the receiving unit 101 receives an input sentence to be translated. The receiving unit 101, for example, may be realized by a text input system such as a keyboard, a mouse, a handwritten word recognition system, or an optical character reader (OCR). The receiving unit 101 may also be realized by a speech input system that is combined with a speech recognition apparatus.

The example translating unit 102 translates an input sentence into a target language with the example-based translation system. Specifically, the example translating unit 102 searches translation examples that include an example source sentence similar to the input sentence received by the receiving unit 101, in the example storage unit 120. The example translating unit 102 then outputs a set of a first likelihood, word alignment information, and an example translation result, as an example translation candidate. The first likelihood is a likelihood that indicates a certainty of a translation example that is defined depending on a degree of similarity. The word alignment information is example correspondence information that indicates a correspondence relationship of the words between the input sentence and the example source sentence being used. The example translation result is made by using the translation examples.

In the present embodiment, all the similar translation examples are regarded as processing targets, and all the example translation candidates are output as a collection of example translation candidates. The example translating unit 102 may be formed so as to limit the number of example translation candidates to output, based on the first likelihood. Alternatively, the example translating unit 102 may be formed so as to output only the required number of example translation candidates.

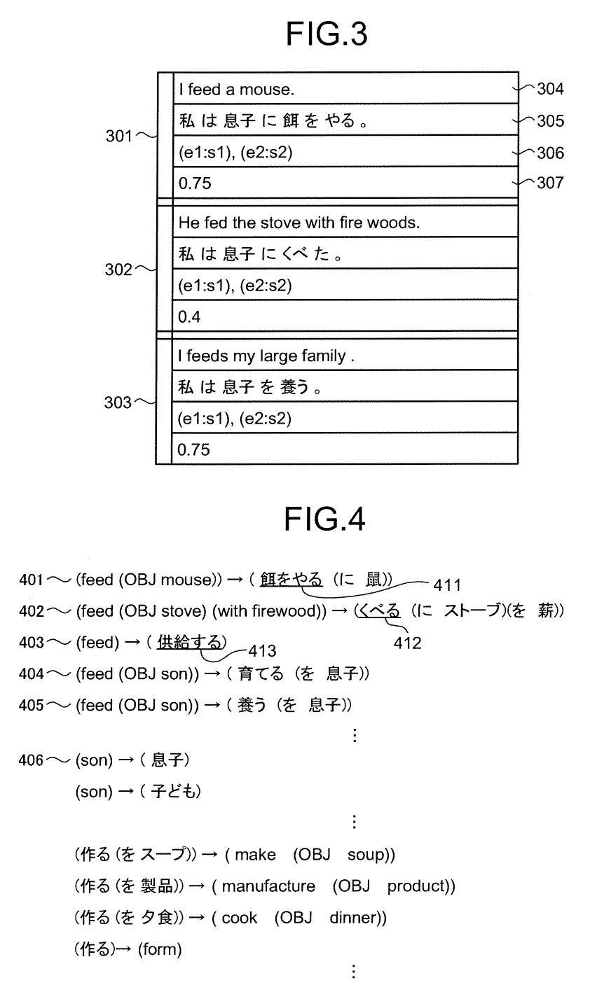

FIG. 3 is a diagram illustrating a collection of example translation candidates including example translation candidates 301, 302, and 303 that are obtained with respect to an input sentence “I feed my son.”, when the translation examples as in FIG. 2 are stored in the example storage unit 120.

For example, the example translation candidate 301 shows an example translation candidate that can be obtained based on the example 201 (“I feed a mouse.”) shown in FIG. 2. The example translation candidate 301 includes a Japanese sentence 305 as an example translation result, and gives word alignment information 306 ((e1:s1), (e2:s2)) as the word alignment information between an example source sentence 304 and the input sentence. Referring to FIG. 3, a likelihood 307 of the example translation candidate 301 is 0.75. Meanwhile, “s1, s2, . . . ” are identifiers that identify the words in the input sentence, and numerical values that correspond to an order of appearance are given from the start of the sentence.

The word alignment information 306 shows that the first word in the input sentence corresponds to the first word “I” in the example source sentence, and the second word in the input sentence corresponds to the second word “feed” in the example source sentence.

Therefore, by referring to the word alignment information between the input sentence and the example source sentence, and also to the translation alignment information between the example source sentence of the translation examples that are stored in the example storage unit 120 and the example translation sentence, it is possible to know how the words in the input sentence have been replaced with the words in the example translation result.

For example, using the word alignment information 306 shown in FIG. 3, the word “I” in the input sentence can be determined to correspond to the first word “I” in the example source sentence 304. By referring to the translation alignment information 209 shown in FIG. 2, it is possible to know that the first word “I” in the English sentence 208 being the example source sentence, corresponds to the first word 210 in the Japanese sentence 207 being the example translation sentence.

Referring back to FIG. 1, the translation-word-candidate generating unit 103 translates an input sentence, using a second translation system that is different from the system the example translating unit 102 uses. The translation-word-candidate generating unit 103 then generates candidates for a translation result (hereinafter, translation word candidate) selected by the second translation system, with each word that forms the input sentence (hereinafter, input word). The translation-word-candidate generating unit 103 generates translation word candidates that correspond to each input word, based on a translation result whose second likelihood is equal to or more than a predetermined threshold value. The second likelihood is a likelihood that shows a certainty of the translation result obtained by the second translation system.

In the present embodiment, the translation-word-candidate generating unit 103 uses a transfer system that belongs to the rule-based translation system, as the second translation system. The transfer system is a translation system that obtains a syntax structure through a word analysis and a syntax analysis with respect to an input sentence, converts the input sentence into a structure of a target language using conversion rules with a condition of the syntax structure being obtained, and generates a desired target language sentence based on the structure.

It should be noted that the second translation system is not limited to the rule-based translation system. As long as the system is different from the example translation used in the example translating unit 102, any system such as the statistics-based translation system can be used.

In conversion rules 401 through 406 shown in FIG. 4, the left side shows a conditional expression related to a structure before the conversion, and the right side shows a structure after the conversion, having a symbol “I-” in the center. Various types of conversion rules may be defined, such as a condition of structural relationships among a plurality of words, as in the conversion rule 401 shown in FIG. 4. For another example, a relatively simple conversion with the only condition of words in the source language to be translated is also available, as shown in the conversion rule 406.

In the transfer system, a translation sentence is generated by selecting the most appropriate combination from the rules. The translation-word-candidate generating unit 103 according to the present embodiment generates translation word candidates by listing candidates obtained as a result of the translation process using the transfer system, with respect to each word in the input sentence.

In the present embodiment, a degree of compatibility with the rules of the transfer system is used as a likelihood of a translation result (second likelihood). In other words, the translation-word-candidate generating unit 103 generates a translation result based on a combination of rules with the highest degree of compatibility.

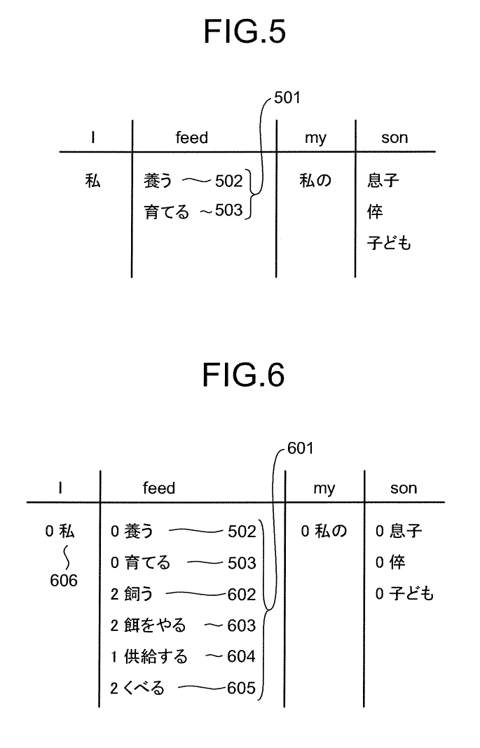

FIG. 5 is a diagram illustrating an output of the translation-word-candidate generating unit 103 with respect to the input sentence “I feed my son.” For example, a collection of translation word candidates 501 shown in FIG. 5 shows a collection of translation word candidates of the word “feed”, and indicates that two Japanese words 502 and 503 correspond to that word.

Referring back to FIG. 1, the translation-word-candidate adding unit 104 further obtains all the translation word candidates into which the input word can be possibly translated into, and adds the translation word candidates to the collection of the translation word candidates that are listed by the translation-word-candidate generating unit 103. Specifically, the translation-word-candidate adding unit 104 generates translation word candidates corresponding to each input word, based on the translation result whose likelihood of the second translation system (second likelihood) is equal to or more than a second threshold value. The second threshold value is smaller than the threshold value used by the translation-word-candidate generating unit 103. The translation-word-candidate adding unit 104 then adds the translation word candidates to the translation word candidates that are already generated by the translation-word-candidate generating unit 103.

The translation-word-candidate generating unit 103 obtains translation words, i.e. a translation sentence being a translation result, by the translation system that is the transfer system. In the system, the translation word that is selected eventually is guided based on a combination of the most appropriate conversion rules being selected during the translation process.

The translation-word-candidate adding unit 104 relaxes the condition of the most appropriate conversion rules, and adds the translation word candidate under the applied rules to the collection of the translation word candidates, by applying any rule related to the conversion of the target word.

For example, the translation-word-candidate generating unit 103 respectively guides the words 502 and 503 that are translation word candidates included in the collection of the translation word candidates 501 shown in FIG. 5, from the conversion rules 404 and 405 shown in FIG. 4.

By ignoring application conditions and only focusing on word conversion between the source language and the target language, for example, the conversion rules 401, 402, and 403 shown in FIG. 4 that include the word “feed” can be applied with respect to the word “feed”. In other words, the translation-word-candidate adding unit 104 can add a Japanese word 411, a Japanese word 412, and a Japanese word 413 as new translation word candidates with respect to the word “feed”, using the conversion rules 401, 402, and 403.

After adding the translation word candidates, the translation-word-candidate adding unit 104 gives a penalty to which the candidate evaluating unit 105 later refers to the listed translation word candidates. In the present embodiment, a small penalty is set when a translation word candidate has a high reliability, and a large penalty is set when a translation word candidate has a low reliability.

The translation word with the relaxed conditions may be considered to have a low reliability, compared with the translation word that is determined to be the most appropriate during the normal translation process in the second translation system. This is because the translation word with the relaxed conditions does not sufficiently match a situation in which the translation word conditioned by the rules can be used. The translation word candidate that is obtained by relaxing the strictly defined rules with the condition of the relationship between the words, such as the conversion rule 404 shown in FIG. 4, is considered to have a low reliability as the translation word. This is because a degree of relaxation of the conditions is considered to be higher than the translation word candidate that is obtained by a simple word conversion, such as the conversion rule 403.

The translation-word-candidate adding unit 104 gives a penalty to each translation word candidate, when being selected. This is to consider differences in the degree of reliability with each translation word candidate, and to show differences in the characters of translation word candidates.

Specifically, the translation-word-candidate adding unit 104 gives the translation word candidates listed by the translation-word-candidate generating unit 103, as the candidate with the maximum likelihood that has the highest degree of reliability, no penalty. In other words, a penalty 0 is given. The translation-word-candidate adding unit 104 gives the translation word candidates that are newly added by the translation-word-candidate adding unit 104 different penalties depending on the type of the conversion rules. For example, the translation-word-candidate adding unit 104 gives a penalty 1 to a translation word candidate that is added based only on words. The translation-word-candidate adding unit 104 gives a penalty 2 to a translation word candidate that is added based on a relationship between a plurality of words.

FIG. 6 is a diagram of an output of the translation-word-candidate adding unit 104 with respect to the input sentence “I feed my son.”, as in FIG. 5. For example, a collection of translation word candidates 601 shown in FIG. 6 shows a collection of translation word candidates for the word “feed”. The collection of translation word candidates 601 shows that the penalties for the word 502 and the word 503 are 0, the penalty for a word 604 is 1, and the penalties for a word 602, a word 603, and a word 605 are 2.

The penalties given at the translation-word-candidate adding unit 104 are not limited to discrete values as such. Depending on the mode of translation, continuous values may be assigned to evaluate further in detail. Moreover, for example, the penalty may be formed so as to evaluate a degree of similarity to the words included in a conditioning unit of the conversion rules in the transfer system, and change the penalty depending on the degree of similarity. For example, the statistics-based translation system may be formed so that a probability of converting a certain source language word to a target language word is referenced, and the inverse is adopted as the penalty, by assuming that the probability is a degree of certainty of the translation.

The translation-word-candidate adding unit 104 is not an essential constituent, and what is required is to provide the most appropriate translation word candidate that matches the rules generated by the translation-word-candidate generating unit 103.

Referring back to FIG. 1, with each example translation candidate that belongs to the collection of example translation candidates being an output of the example translating unit 102, the candidate evaluating unit 105 selects the example translation candidate with the maximum likelihood. This is performed by referring to the collection of translation word candidates listed by the translation-word-candidate generating unit 103 and the translation-word-candidate adding unit 104. As shown in FIG. 1, the candidate evaluating unit 105 includes a changing unit 105a and a candidate selecting unit 105b.

The changing unit 105a determines whether a word included in the example translation candidates (hereinafter, translation word) is included in the translation word candidates being listed, for each example translation candidate. If the translation word is not included in the translation word candidate, the likelihood (first likelihood) of the example translation candidate is lowered. Using this function, a possibility of selecting the example translation candidate that includes any translation word candidate not selected by the second translation system as a translation result is reduced.

In the present embodiment, if any of the translation word that is not included in the translation word candidate is in presence, the changing unit 105a dismisses the example translation candidate so as not to select as a translation result. In other words, the changing unit 105a sets the likelihood of such an example translation candidate to 0. Accordingly, the example translation candidate including the translation word candidate that cannot be adopted in the second translation system is excluded, thereby improving an accuracy of the example translation. The changing unit 105a may also be formed so as to change the value that lowers the likelihood, depending on the number of translation words that are not included in the translation word candidates.

The candidate selecting unit 105b selects an example translation candidate with the maximum likelihood from the example translation candidates, as a translation result. The candidate selecting unit 105b of the present embodiment further calculates a penalty of each example translation candidate. The candidate selecting unit 105b then selects an example translation candidate with the minimum penalty, from the example translation candidates with the maximum likelihood, as a translation result. The candidate selecting unit 105b calculates the penalty of the example translation candidate, by adding the penalties of the translation word candidates that correspond to the translation words included in the example translation candidates. By such functions, the example translation candidate that includes the translation word candidate with a high degree of reliability can be selected as a translation result, thereby enabling to further improve the accuracy of the example translation.

When the translation-word-candidate adding unit 104 is not included in the configuration, a penalty of the translation word candidate is not calculated. Accordingly, the calculation of the penalty by the candidate selecting unit 105b with each example translation candidate and the evaluation based on the penalty being calculated are not required.

Instead of selecting a candidate using the two criteria of the likelihood and the penalty, it may be formed so that the likelihood is changed corresponding to the penalty, and the candidate with the maximum likelihood is selected by only using the likelihood after being changed, as a criterion. In other words, the changing unit 105a changes the likelihood (first likelihood) of the example translation candidate corresponding to the penalty of each example translation candidate, and then the candidate selecting unit 105b selects the example translation candidate with the maximum likelihood, using the likelihood after being changed.

The output controlling unit 106 controls a process to output the translation result that is selected by the candidate selecting unit 105b. The output controlling unit 106, for example, may be realized by various known systems, such as image output by a display apparatus, print output by a printer, and synthetic voice output by a voice synthesizer. It is also possible to form such systems so as to be switched as required, or by combining a plurality of such systems.

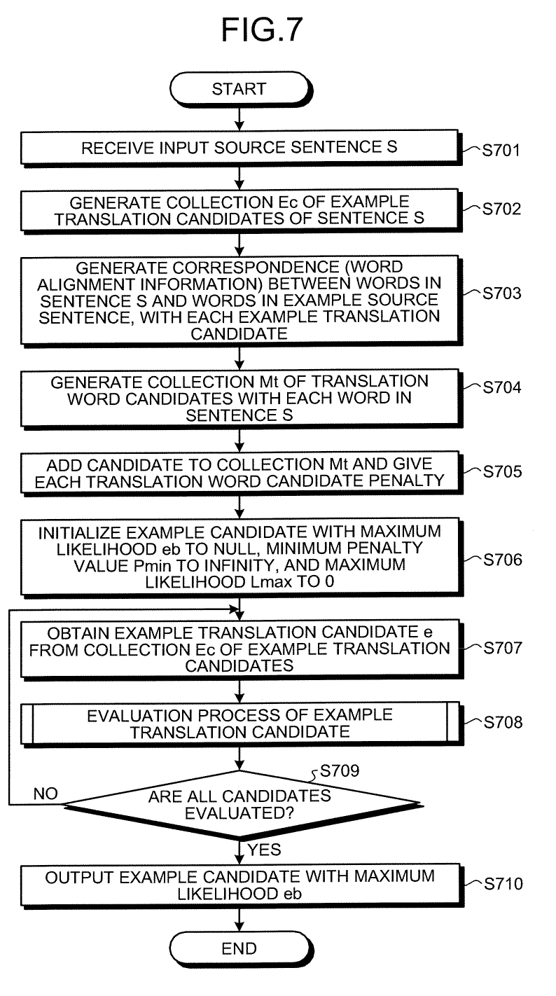

Next, a machine translation process performed by the machine translation apparatus 100 according to the present embodiment that is formed in this manner will be explained with reference to FIG. 7.

The receiving unit 101 receives an input sentence S (step S701). The example translating unit 102 executes an example translation by obtaining an example translation sentence corresponding to an example source sentence that is similar to the input sentence S, from the example storage unit 120, as an example translation candidate. The example translating unit 102 then generates a collection Ec of example translation candidates (step S702). At this time, the example translating unit 102 generates word alignment information that shows a correspondence between a word in the input sentence S (input word) and a word in an example source sentence (hereinafter, source sentence word), with each example translation candidate being obtained (step S703).

The translation-word-candidate generating unit 103 executes a translation by the transfer system, with respect to the input sentence S, and generates a collection Mt of translation word candidates with each input word (step S704). The translation-word-candidate adding unit 104 further executes translation by the transfer system, with the conversion rules under which the conditions are being relaxed, and adds a translation word candidate being obtained to the collection Mt of translation word candidates. At the same time, the translation-word-candidate adding unit 104 gives a penalty to each translation word candidate in the collection Mt of the translation word candidates (step S705).

The candidate evaluating unit 105 initializes a variable used to evaluate each candidate in the collection Ec of the example translation candidates. Specifically, the candidate evaluating unit 105 sets an example candidate eb with the maximum likelihood to null, sets the minimum penalty Pmin to infinity, and sets the maximum likelihood Lmax to 0 (step S706).

The initial value set to the minimum penalty Pmin is not limited to infinity, but any value may be set depending on desired translation performance. For example, if the initial value is set to 0, all the example translation candidates with which the penalties are calculated can be formed so as not to be selected.

The candidate evaluating unit 105 obtains an unevaluated example translation candidate e from the collection Ec of example translation candidates (step S707). Then, the candidate evaluating unit 105 executes an evaluation process of the example translation candidate, by evaluating the example translation candidates e being obtained, and selecting the example translation candidate with the maximum likelihood (step S708). A detail of the evaluation process of the example translation candidates will be explained later. By executing the evaluation process of the example translation candidates, the example translation candidate with the maximum likelihood at that point is set as the example candidate eb with the maximum likelihood.

The candidate evaluating unit 105 determines whether all the example translation candidates are processed (step S709). If not all the candidates are processed (NO at step S709), the candidate evaluating unit 105 selects the next example translation candidate e, and repeats the process (step S707).

If all the example translation candidates are processed (YES at step S709), the output controlling unit 106 outputs the example candidate eb with the maximum likelihood (step S710), and finishes the machine translation process.

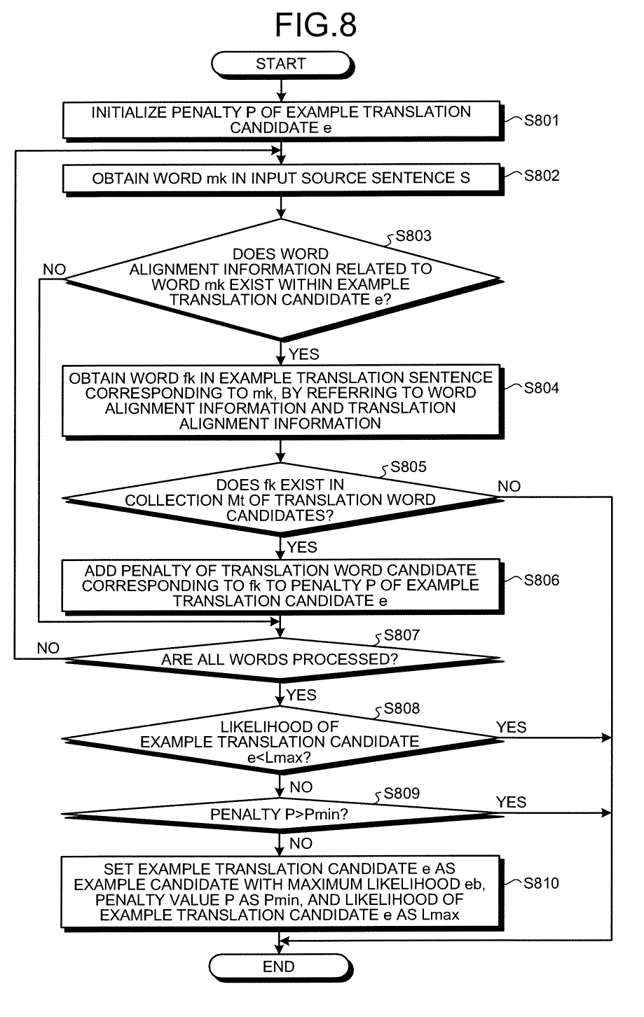

Next, the evaluation process of the example translation candidates at step S708 will be described in detail with reference to FIG. 8.

The candidate evaluating unit 105 initializes a penalty P of the example translation candidate e to be evaluated to 0 (step S801). The candidate evaluating unit 105 then obtains a word (input word) mk in the input sentence S (step S802).

The changing unit 105a determines whether word alignment information related to the word mk exists within the example translation candidate e (step S803). For example, assume that an English sentence “I feed a mouse.” is input as an input sentence, and the first word “I” whose identifier is “s1” is determined as the word mk. In this case, with the example translation candidate 301 shown in FIG. 3, the alignment information that includes “s1” is included in the word alignment information 306. Accordingly, the changing unit 105a determines that the word alignment information related to the word mk exists.

When the word alignment information related to the word mk exists (YES at step S803), the changing unit 105a refers to the word alignment information and the translation alignment information, and obtains a word (translation word) fk that is included in the example translation sentence corresponding to the word mk (step S804).

For example, with regard to the first word “I” in the input sentence (“I feed a mouse.”), the first word “I” (identifier=“e1”) in the example source sentence is obtained based on the word alignment information 306 ((e1:s1), (e2:s2)) shown in FIG. 3. Then, based on the translation alignment information 209 of the example 201 shown in FIG. 2, the word 210 that has the identifier “j1” corresponding to the identifier “e1” is obtained as the word fk.

The changing unit 105a then determines whether the word fk exists within the collection Mt of the translation word candidates corresponding to the word mk (step S805). If the word fk does not exist (NO at step S805), the changing unit 105a dismisses the example translation candidate e being evaluated, and finishes the evaluation process of the example translation candidates. The dismissal of the example translation candidate e corresponds to a change in the likelihood of the example translation candidate e to 0.

When the word fk exists within the collection Mt of the translation word candidates corresponding to the word mk (YES at step S805), the candidate selecting unit 105b adds a penalty of the translation word candidate corresponding to the word fk, to the penalty P of the example translation candidate e (step S806).

The candidate selecting unit 105b determines whether all the words in the input sentence S are processed (step S 807). If not all the words are processed (NO at step S807), the next word mk is obtained to repeat the process (step S802).

If all the words are processed (YES at step S807), the candidate selecting unit 105b determines whether the likelihood of the example translation candidate e is smaller than the present maximum likelihood Lmax (step S808).

If the likelihood of the example translation candidate e is smaller than the maximum likelihood Lmax (YES at step S808), the evaluation process of the example translation candidates is finished, to dismiss the example translation candidate e being evaluated. If the likelihood of the example translation candidate e is not smaller than the maximum likelihood Lmax (NO at step S808), the candidate selecting unit 105b determines whether the penalty P of the example translation candidate e is larger than the present minimum penalty Pmin (step S809).

If the penalty P is larger than the minimum penalty Pmin (YES at step S809), the evaluation process of the example translation candidates is finished, to dismiss the example translation candidate e being evaluated. If the penalty P is not larger than the minimum penalty Pmin (NO at step S809), the candidate selecting unit 105b sets the example translation candidate e being evaluated, as the example candidate eb with the maximum likelihood. At the same time, the candidate selecting unit 105b sets the penalty P to the minimum penalty Pmin, and sets the likelihood of the example translation candidate e to the maximum likelihood Lmax (step S810).

As described above, the changing unit 105a can eliminate the example translation candidate including the translation word candidate that cannot be adopted in the second translation system. The candidate selecting unit 105b can also adopt the example translation candidate including the translation example with a higher degree of reliability.

Next, a specific example of a machine translation process performed by the machine translation apparatus 100 according to the present embodiment configured as above will be explained.

In the following, assume that an English sentence “I feed my son.” is received as an input sentence S (step S701). At this time, assume that a collection Ec of example translation candidates including three example translation candidates 301, 302, and 303 shown in FIG. 3 is obtained, as an output of the example translating unit 102 (step S702). Moreover, assume that a collection Mt of translation word candidates shown in FIG. 6 is obtained, as an output of the translation-word-candidate generating unit 103 (step S704).

Among the three example translation candidates shown in FIG. 3, a grammatically correct expression that appeals to human intuition is the example translation candidate 303. In a translation technique of the related art, because the candidate with the maximum likelihood is selected from the example translation candidates, a problem occurs in that the example translation candidate 301 having an unnatural translation is also possibly output.

Under the above assumption, to select the example translation candidate with the maximum likelihood, the process is continued by respectively initializing the example candidate eb with the maximum likelihood to null, the minimum penalty Pmin to infinity, and the maximum likelihood Lmax to 0 (step S706).

At present, the three unprocessed example translation candidates exist in the collection Ec of the example translation candidates. Accordingly, the evaluation process of the example translation candidates is called for the first example translation candidate 301 (step S708).

With the evaluating process of the example translation candidates, as an initializing process, the penalty P is initialized to 0 (step S801). Then, the first word “I” in the input sentence S is obtained and assigned to the word mk (step S802). Because the first input word “I” has the word alignment information (YES at step S803), a word in the example translation sentence corresponding to the input word “I” is obtained and stored in the word fk (step S804). This is performed by referring to the word alignment information and the translation alignment information held by the example storage unit 120. In this case, the Japanese word 210 shown in FIG. 2 is assigned to the word FK.

In the collection Mt of the translation words candidates with respect to the input word “I”, the Japanese word 606 exists as shown in FIG. 6, and this corresponds to the word fk (word 210 in FIG. 2) (YES at step S805). Although a penalty of the word 606 is added to the penalty P of the example translation candidate 301 (step S806), because the penalty of the word 606 is 0, the penalty P becomes 0.

After this, the process is repeated with the next input word (NO at step S807). In other words, the second word “feed” in the input sentence S is obtained, and assigned to the word mk (step S802). Because the second input word “feed” has the word alignment information (YES at step S803), a word in the example translation sentence corresponding to the input word “feed” is obtained and stored in the word fk (step S804). This is performed by referring to the word alignment information and the translation alignment information held by the example storage unit 120. In this case, a Japanese phrase 211 shown in FIG. 2 is assigned to the word fk.

In the collection Mt of the translation word candidates corresponding to the input word “feed”, the Japanese word 603 exists as shown in FIG. 6, and this coincides with the word fk (phrase 211 in FIG. 2) (YES at step S805). Although a penalty of the word 603 is added to the penalty P of the example translation candidate 301 (step S806), because the penalty of the word 603 is 2, the penalty P becomes 2.

Accordingly, when the evaluation of all the input words in the input sentence S is finished, in this example, the penalty P becomes 2.

Because the likelihood 0.75 of the example translation candidate 301 is larger than the present maximum likelihood Lmax (=0) (YES at step S808), the penalty P and the present minimum penalty Pmin are compared (step S809). Because the penalty P (=2) is smaller than the minimum penalty Pmin (=infinity) (NO at step S809), the example translation candidate 301 is set as the example candidate eb with the maximum likelihood. Moreover, the present penalty P of 2 is set as the minimum penalty Pmin, and the likelihood of the example translation candidate 301 of 0.75 is set as the maximum likelihood Lmax (step S810). With this, the evaluation process of the example translation candidates 301 is finished.

At this stage, in the collection Ec of the example translation candidates, the example translation candidates 302 and 303 shown in FIG. 3 still remain as unevaluated example translation candidates (NO at step S709). Accordingly, the next example translation candidate 302 is obtained (step S707) to further execute the evaluation process of the example translation candidates (step S708).

With respect to the example translation candidate 302, when all the input words are processed by the evaluation process of the example translation candidates (YES at step S807), the penalty P is calculated to be 2.

Because the likelihood 0.4 of the example translation candidate 302 is smaller than the present maximum likelihood Lmax (=0.75) (NO at step S808), the example translation candidate 302 is not selected as the example candidate eb with the maximum likelihood, and the evaluating process of the example translation candidates is finished.

At this stage, in the collection Ec of the example translation candidates, the example translation candidate 303 shown in FIG. 3 still remains as an unevaluated example translation candidate (NO at step S709). Accordingly, the example translation candidate 303 is obtained (step S707) to further execute the evaluation process of the example translation candidates (step S708).

With respect to the example translation candidate 303, when all the input words are processed by the evaluation process of the example translation candidates (YES at step S807), the penalty P is calculated to be 0.

Because the likelihood 0.75 of the example translation candidate 303 is equal to the present maximum likelihood Lmax (=0.75) (YES at step S808), the penalty P and the present minimum penalty Pmin are compared (step S809). Because the penalty P (=0) is smaller than the minimum penalty Pmin (=2) (NO at step S809), the example translation candidate 303 is set as the example candidate EB with the maximum likelihood. The present penalty of 0 is set as the minimum penalty Pmin, and the likelihood of the example translation candidate 303 of 0.75 is set as the maximum likelihood Lmax (step S810). With this, the evaluation process of the example translation candidates of the example translation candidate 303 is finished.

At this stage, because an unevaluated example translation candidate does not exist in the collection Ec of the example translation candidates (YES at step S709), the example translation candidate 303 shown in FIG. 3 that is the example candidate eb with the maximum likelihood is output as a translation result (step S710).

As described above, by giving the example-based translation system knowledge of the translation word candidates obtained by the rule-based translation system, which is the second translation system, even if an inappropriate translation sentence is generated by the example-based translation system, the inappropriate translation sentence can be dismissed. As a result, more appropriate translation sentences are apt to be selected, thereby improving the accuracy of the example translation.

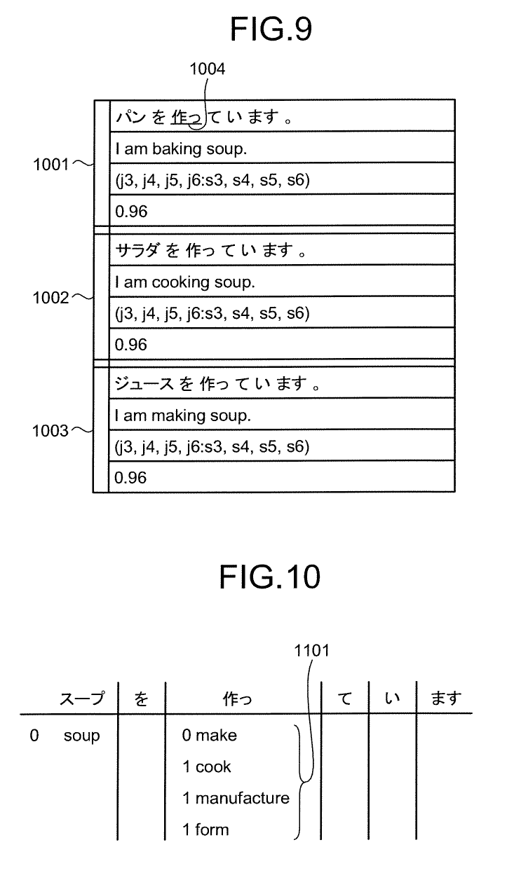

Next, an alternative specific example of the machine translation process performed by the machine translation apparatus 100 according to the present embodiment will be explained with reference to FIGS. 9 and 10.

In the following, assume that a Japanese sentence that means “I am making soup.” is received as an input sentence S (step S701). At this time, assume that a collection Ec of example translation candidates including three example translation candidates 1001, 1002, and 1003 shown in FIG. 9 is obtained as an output of the example translating unit 102 (step S702). Moreover, assume that a collection Mt of the translation word candidates shown in FIG. 10 is obtained, as an output of the translation-word-candidate generating unit 103 (step S704).

The three example translation candidates shown in FIG. 9 have the same degree of likelihood (0.96) output by the example translating unit 102. Accordingly, the example translation system of the related art cannot narrow down the solution properly. However, among the example translation candidates being output, a grammatically correct expression that appeals to human intuition is only the example translation candidate 1003, i.e. “I am making soup.”

With respect to the example translation candidate 1001, a Japanese word 1004 is translated into the English word “bake(ing)”. This English word does not exist in the collection of the translation word candidates 1101 shown in FIG. 10. Therefore, the example translation candidate 1001 cannot be the example candidate eb with the maximum likelihood.

With respect to the example translation candidate 1002, the Japanese word 1004 is translated into the English word “cook(ing)”. This English word is listed in the collection of the translation word candidates 1101 shown in FIG. 10, with a penalty of 1.

With respect to the example translation candidate 1003, the Japanese word 1004 is translated into the English word “make(ing)”. This English word is listed in the collection of the translation word candidates 1101 shown in FIG. 10, with a penalty of 0.

Therefore, the example translation candidate 1003 that has a smaller penalty is preferred over the example translation candidate 1002 that has a larger penalty. In other words, the example translation candidate 1003 is selected as the example candidate eb with the maximum likelihood for the input sentence S, and an English sentence “I am making soup.” is output as a translation result. This is grammatically correct and appeals to human intuition.

In this manner, the machine translation apparatus 100 according to the present embodiment can dismiss a translation result including a translation word that is not guided by the second translation system, among translation candidates obtained by the example-based translation system. Consequently, even if an unintended and unnatural translation result is generated, the translation result is appropriately eliminated, thereby preventing to give a wrong meaning to a user. Moreover, the example translation result can be narrowed down, depending on the degree of reliability of the translation word candidates obtained by the second translation system. As a result, an example translation result with a higher quality can be output.

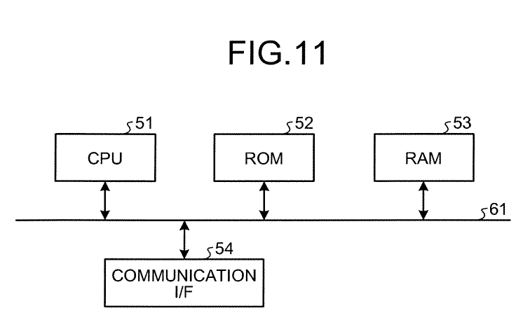

Next, a hardware configuration of the machine translation apparatus 100 according to the present embodiment will be explained with reference to FIG. 11.

The machine translation apparatus 100 according to the present embodiment includes a controlling apparatus such as a central processing unit (CPU) 51, a storage apparatus such as a read only memory (ROM) 52 and a random access memory (RAM) 53, a communication interface (I/F) 54 that communicates through connection to a network, and a bus 61 that connects each unit.

A machine translation program that is executed by the machine translation apparatus 100 according to the present embodiment is provided by being installed in the ROM 52 and the like in advance.

The machine translation program that is executed by the machine translation apparatus 100 according to the present embodiment may be formed so as to be provided by being recorded in computer readable recording media such as a compact disk read only memory (CD-ROM), a flexible disk (FD), a compact disk recordable (CD-R), and a digital versatile disk (DVD) in a file of an installable form or an executable form.

The machine translation program that is executed by the machine translation apparatus 100 according to the present embodiment may be formed so as to be stored in a computer connected to a network such as the Internet, and provided by downloading via the network. The machine translation program that is executed by the machine translation apparatus 100 according to the present embodiment may be formed so as to be provided or distributed via a network such as the Internet.

The machine translation program that is executed by the machine translation apparatus 100 according to the present embodiment has a modular composition including each unit described above (the receiving unit, the example translating unit, the translation-word-candidate generating unit, the translation-word-candidate adding unit, the candidate evaluating unit, and the output controlling unit). As an actual hardware configuration, each unit is loaded on a main storage apparatus when the CPU 51 reads out and executes the machine translation program from the ROM 52, whereby each unit generated on the main storage apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A machine translation apparatus comprising:
an example storage unit configured correspondingly to store an example in a source language and an example in a target language translated from the example in the source language;
a receiving unit configured to receive an input sentence in the source language;
an example translating unit configured to perform an example translation process of obtaining a plurality of example translation candidates translated from the input sentence into the target language, each of which is correlated with a first likelihood indicating a certainty of each of the example translation candidates, based on the example in the target language stored in the example storage unit corresponding to the example in the source language that coincides or nearly coincides with the input sentence;
a generating unit configured to translate the input sentence into the target language by another translation process different from the example translation process, and to generate a translation word candidate showing a candidate for a result of the another translation process with a second likelihood, indicating a certainty of the candidate for the result of the another translation process, being equal to or more than a predetermined first threshold value;
a changing unit configured to determine whether a translation word corresponding to each word included in the example translation candidate exists in the translation word candidate, and to change the first likelihood by subtracting a predetermined value when the translation word does not exist in the translation word candidate; and
a selecting unit configured to select the example translation candidate whose first likelihood is a maximum, from the example translation candidates.

2. The apparatus according to claim 1, wherein the selecting unit preferentially selects the example translation candidate including a translation word included in the translation word candidate with a larger second likelihood, over the example translation candidate including a translation word included in the translation word candidate with a smaller second likelihood.

3. The apparatus according to claim 1, wherein the changing unit further lowers the first likelihood of the example translation candidate including the translation word included in the translation word candidate with the smaller second likelihood, than the first likelihood of the example translation candidate including the translation word included in the translation word candidate with the larger second likelihood.

4. The apparatus according to claim 1, further comprising:
an adding unit configured to add a candidate for a translation result having the likelihood equal to or more than a second threshold value that is smaller than the first threshold value and also smaller than the first threshold value, to the translation word candidate for each word included in the input sentence, among the candidate for the translation result.

5. The apparatus according to claim 4, wherein the selecting unit preferentially selects the example translation candidate including the translation word included in the translation word candidate generated by the generating unit, over the example translation candidate including the translation word included in the translation word candidate added by the adding unit.

6. The apparatus according to claim 4, wherein the changing unit further lowers the first likelihood of the example translation candidate including the translation word included in the translation word candidate added by the adding unit, than the first likelihood of the example translation candidate including the translation word included in the translation word candidate generated by the generating unit.

7. The apparatus according to claim 1, wherein the generating unit translates the input sentence into the target language based on a predetermined translation rule, and generates the translation word candidate whose second likelihood as a degree of compatibility to the translation rule is equal to or larger than the first threshold value, among the candidate for the translation result for each word in the input sentence.

8. The apparatus according to claim 1, wherein
the example storage unit correspondingly stores the example in the source language, the example in the target language, and translation correspondence information showing a correspondence relationship between a source sentence word included in the example in the source language and a translation word included in the example in the target language;
the example translating unit further generates example correspondence information showing a correspondence relationship between the word in the input sentence and the source sentence word included in the example in the source language that coincides or nearly coincides with the input sentence; and
the changing unit obtains the source sentence word corresponding to the word in the input sentence from the example correspondence information, obtains a translation word corresponding to the obtained source sentence word from the translation correspondence information corresponding to the example translation candidate for each example translation candidate, and lowers the first likelihood only by the value when the obtained translation word is not included in the translation word candidate.

9. A machine translation method comprising:
receiving an input sentence in the source language;
performing an example translation process of obtaining a plurality of example translation candidates translated from the input sentence into the target language, each of which is correlated with a first likelihood indicating a certainty of each of the example translation candidates, based on the example in the target language, stored in a example storage unit storing an example in a source language and an example in a target language translated from the example in the source language, corresponding to the example in the source language that coincides or nearly coincides with the input sentence;
translating the input sentence into the target language by another translation process different from the example translation process;
generating a translation word candidate showing a candidate for a result of the another translation process with a second likelihood indicating a certainty of the candidate for the result of the another translation process being equal to or more than a predetermined first threshold value;
determining whether a translation word corresponding to each word included in the example translation candidate exists in the translation word candidate;
changing the first likelihood by subtracting a predetermined value when the translation word does not exist in the translation word candidate; and
selecting the example translation candidate whose first likelihood is a maximum, from the example translation candidates.

10. A computer program product having a computer readable medium including programmed instructions for performing machine translation, wherein the instructions, when executed by a computer, cause the computer to perform:
receiving an input sentence in the source language;
performing an example translation process of obtaining a plurality of example translation candidates translated from the input sentence into the target language, each of which is correlated with a first likelihood indicating a certainty of each of the example translation candidates, based on the example in the target language, stored in a example storage unit storing an example in a source language and an example in a target language translated from the example in the source language, corresponding to the example in the source language that coincides or nearly coincides with the input sentence;
translating the input sentence into the target language by another translation process different from the example translation process;
generating a translation word candidate showing a candidate for a result of the another translation process with a second likelihood indicating a certainty of the candidate for the result of the another translation process being equal to or more than a predetermined first threshold value;
determining whether a translation word corresponding to each word included in the example translation candidate exists in the translation word candidate;
changing the first likelihood by subtracting a predetermined value when the translation word does not exist in the translation word candidate; and
selecting the example translation candidate whose first likelihood is a maximum, from the example translation candidates.
